(19) United States
(12) Patent Application Publication
(10) Pub. No.: US 2011/0182177 A1
(43) Pub. Date: Jul. 28, 2011

(54) Access control of Machine-to-Machine Communication via a Communications Network

(76) Inventors: Ivo Sedlacek, Lund (SE); Håkan Palm, Vaxjo (SE); Veijo Vãnttinen, Espoo (FI)

(21) Appl. No.: 12/961,564

(22) Filed: Dec. 7, 2010

Related U.S. Application Data
(60) Provisional application No. 61/267,480, filed on Dec. 8, 2009.

(51) Int. Cl. H04L 12/26

(52) U.S. Cl. 370/230

(57) ABSTRACT

A first communications device communicates with a second communications device by means of a communications network. The first communications device receives information from the communications network, wherein the information comprises a network load value and a mean delay time value. The first communications device ascertains whether the network load value satisfies a predetermined relationship with respect to a threshold load value and if the predetermined relationship is satisfied then it communicates a data packet over the network at a designated time that is ascertained by ascertaining one of a number of different wait time values, wherein the ascertained wait time value has a mathematical expectation equal to the mean delay time value. The first communication device then waits an amount of time corresponding to the ascertained wait time, without attempting to communicate the data packet over the communications network during the time in which the first communications device is waiting.

### CROSS REFERENCE TO RELATED APPLICATIONS

This application claims the benefit of U.S. Provisional Application No. 61/267,480, filed Dec. 8, 2009, which is hereby incorporated herein by reference in its entirety.

### BACKGROUND

The present invention relates to machine-to-machine communication by means of a communications network, and more particularly to access control of machine-to-machine communication by means of a communications network.

The communication of information (e.g., one or more data packets) from one device to another is generally known. Such communication can take place by means of a dedicated link between the devices, or by means of a communications network. As used herein, the term “communications network” is used broadly to denote private and/or public networks that provide, for example and without limitation, the routing of data from one or more devices to other ones or groups of devices connected to the network. FIG. 1 illustrates a first communication device 101 that is able to communicate with a second device 103 by means of a communications network 105 to which each is connected. Other communication devices 107 are also connected to the communications network.

As is well-known, networks may themselves be made up of one or more nodes 109 through which information passes on its way to a destination. In some circumstances, any of the communication devices 101, 103, 107 may intend for some element or node 109 within the communications network itself to be the intended recipient of the information rather than one of the communication devices 101, 103, 107.

Communications networks can take many forms, and one or more links within any communications network can be wired or wireless. Cellular communication systems employ communications networks as infrastructure to communicate many forms of information from a source to one or more destinations. Cellular communication systems are typically configured to conform to any of a number of well known standards, such as but not limited to the Global System for Mobile communication (GSM), Code Division Multiple Access (CDMA), Time Division-synchronous CDMA (TD-SCDMA), Wideband CDMA (WCDMA) and Long Term Evolution (LTE) systems. FIG. 2 is a diagram illustrating a common feature found in most cellular communication systems: a serving node 201 (depending on the system, it can be called a “base station”, a Node B, an evolved Node B (“eNodeB” or “eNB”)) serves user equipment (UE) 203 (e.g., a mobile terminal) that is located within the serving node's geographical area of service, called a “cell” 205. For convenience, the term “serving node” will be used henceforth throughout this document, but any such references are not intended to limit the scope of the invention to any one particular system. Thus, references to “serving node” are intended to also refer to “base stations”, “Node B's”, “eNodeB's”, “eNB's”, and also to any equivalent node in a cellular communication system.

Communication is bidirectional between the serving node 201 and the UE 203. Communications from the serving node 201 to the UE 203 are referred to as taking place in a “downlink” direction, whereas communications from the UE 203 to the serving node 201 are referred to as taking place in an “uplink” direction.

In the context of a cellular communication system, a UE 201 is a form of communication device (e.g., any of the communication devices 101, 103, 107), whereas the serving node 201 is one node within a communications network 105.

Modern communication devices 101, 103, 107 can perform many types of communication functions. For example, the traditional cellular telephone communicates voice information to another telephone (either cellular or land-line), and this function is still in widespread use. However, communication devices 101, 103, 107 can also communicate other types of information, such as but not limited to still picture, motion video, and text information.

The high level applications running within the communication device have traditionally been under the control of a human operator. In this context, the human has had control over the timing of a data transmission, for example, by interacting with some aspect of a user interface in the communication device (e.g., a switch or touch screen).

However, it is expected that applications relying on machine-to-machine communications (i.e., communications that take place without any human participation) will also become more widespread. For example, machine-to-machine communication is going to be defined in the 3rd Generation Partnership Project (3GPP) Rel-10 specification for mobile communications (see 3GPP TS 22.368). A main difference between machine-to-machine communication and “regular” communication (i.e., those under the direction of one or more human operators) is that the top layer of the application is an algorithm that can be standardized.

One aspect of the 3GPP TS 22.368 (see Section 7.2.3) is the inclusion of a time tolerant optimization category, which is intended for use with what it calls “Machine Type Communication (MTC) devices” (another term for the machine-to-machine communication devices that have been discussed) that can delay their data transfer. For the time tolerant feature, the standard requires that the network operator be able to restrict access to the network and to dynamically limit the amount of data that the MTC devices can transfer, in a specific area (e.g., in a defined set of cells), when the level of network load is greater than a (pre-) defined load threshold. The network operator is capable of (pre-) defining load thresholds per MTC subscription. The specification also defines that the MTC devices need to be capable of determining the load on the network passively. This means that some sort of network load information (either explicit or implicit) should be provided to the MTC device without the MTC having to make active measurements.

In order to meet the requirement that the MTC device be capable of determining the network load passively, information that allows each MTC to assess the level of network load is broadcast by the network to the MTC devices. The load information could be an explicit indicator of network load, but it need not be. It could instead be an implicit indicator such as, but not limited to, an indicator of what class of MTC devices are presently barred from accessing the communications network. When only the lowest class MTC devices (or none at all) are barred, this can be taken as an implicit indicator that the present network load is low. Conversely, when even the highest class MTC devices are barred, this can be taken as an implicit indicator that the present network load is high. As used herein, the term “load indication” is intended to include both types of indications, explicit and implicit.

In response to receiving the load indication, each MTC device then compares the received load information with the threshold and sends data only when the load of the network is under the load threshold for its MTC subscription.

The inventors have recognized that a problem with the above-described strategy is that, if the network broadcasts the current load and the time tolerant MTC devices wait for that load value to, for example, fall below a certain threshold, then when the threshold condition is satisfied all of the time tolerant MTC devices start sending data at the same time. This massive amount of data sending attempts will increase the load of the network again and the network will need to broadcast a new higher network load value. In response to the new higher network load value, the time tolerant MTC devices will stop sending data. As the time tolerant MTC devices stop sending data, the network load is reduced, and the network then broadcasts a lower network load value which again causes the MTC devices to detect that the threshold condition has been satisfied and the entire cycle starts again with the same results repeating over and over.

It is noted that this problem is relatively new because in the more conventional human-controlled communications, network specifications can provide mechanisms that limit the MTC devices' access to the traffic by for example simply barring it when necessary. However, simultaneous attempts to access the communications network by multiple devices when the bar is lifted are unlikely to occur because it is expected that each human user will decide for him/herself when to periodically re-attempt the failed request.

It is therefore desired to provide mechanisms that enable MTC devices to utilize a communications network in a manner that overcomes the above-described problems.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in a methods and apparatuses for operating a first communications device to communicate with a second communications device by means of a communications network. The first communications device receives information from the communications network, wherein the information comprises a network load value and a mean delay time value. The first communications device ascertains whether the network load value satisfies a predetermined relationship with respect to a threshold load value and if the predetermined relationship is satisfied then the first communications device communicates a data packet over the network at a designated time. The first communications device ascertains the designated time by ascertaining one of a plurality of different wait time values, wherein the ascertained one of the plurality of wait time values has a mathematical expectation equal to the mean delay time value. The first communications device then waits an amount of time corresponding to the ascertained wait time, wherein no attempt is made to communicate the data packet over the communications network during the amount of time in which the first communications device is waiting.

In some embodiments, the plurality of different wait time values range from zero to twice the mean delay time value. In some but not necessarily all of these embodiments, the plurality of different wait time values are symmetrically distributed above and below the mean delay time value.

In some embodiments, ascertaining one of the plurality of different wait time values comprises drawing a uniform random number having a value between zero and one; and ascertaining the one of the plurality of different wait time values as the mathematical product of the drawn uniform random number and twice the mean delay time.

In some embodiments, ascertaining one of the plurality of different wait time values comprises drawing a uniform random number having a value between zero and one; and ascertaining the one of the plurality of different wait time values in a manner that satisfies:

wait time value=MeanTime+(RAND[0 . . . 1]−0.5)*MeanTime,

where RAND[0 . . . 1] is a random number function generating a uniform distribution of numbers between 0 and 1, and MeanTime is the mean delay time value.

In some alternative embodiments, ascertaining one of the plurality of different wait time values comprises drawing a uniform random number having a value between zero and two; and ascertaining the one of the plurality of different wait time values as the mathematical product of the drawn uniform random number and the mean delay time.

Some embodiments further include, subsequent to communicating the data packet over the network at the designated time, communicating one or more additional data packets without ascertaining additional designated times for communicating the one or more additional data packets.

Some embodiments further include the second communication device using the communications network to communicate the information to a plurality of communication devices, wherein the plurality of communication devices comprises the first communication device.

In some embodiments, waiting the amount of time corresponding to the ascertained wait time comprises operating the communication device in a power saving mode wherein communication circuitry of the communication device operates at a reduced power state.

In some embodiments, the network load value indicates a class of communication devices that are barred from accessing the network.

In some embodiments, the network load value is within a predefined range of values and indicates a percentage of communication devices that should be barred from accessing the communications network; and operation of the device involves the first communication device determining the threshold load value by randomly drawing a value from the predefined range of values.

### BRIEF DESCRIPTION OF THE DRAWINGS

The objects and advantages of the invention will be understood by reading the following detailed description in conjunction with the drawings in which:

FIG. 1 is a diagram illustrating a first communication device that is able to communicate with a second device by means of a communications network to which is connected the first and second and other communication devices.

FIG. 2 is a diagram illustrating a serving node that serves a user equipment (UE) in a cellular communication system.

FIG. 3 is a block diagram illustrating a communication device that interacts with a communications network 303.

FIG. 4 is, in one respect, a flow diagram of steps/processes that are performed by a communications device in accordance with aspects of the invention.

FIG. 5a is a graph of a uniform distribution of wait time values between zero and twice the mean delay value, with an associated uniform probability density function over these values.

FIG. 5b is a graph of a uniform distribution of wait time values between 0.5 times the mean delay value and 1.5 times the mean delay value, with an associated uniform probability density function over these values.

FIG. 6a is, in one respect, a flow diagram of steps/processes that are performed by a communications device in accordance with aspects of the invention for ascertaining one of a plurality of different wait time values, wherein the ascertained one of the plurality of wait time values has a mathematical expectation equal to the mean delay time value.

FIG. 6b is, in one respect, a flow diagram of steps/processes, that are performed by an alternative embodiment of a communications device in accordance with aspects of the invention for ascertaining one of a plurality of different wait time values, wherein the ascertained one of the plurality of wait time values has a mathematical expectation equal to the mean delay time value.

FIG. 6c is, in one respect, a flow diagram of steps/processes, that are performed by an alternative embodiment of a communications device in accordance with aspects of the invention for ascertaining one of a plurality of different wait time values, wherein the ascertained one of the plurality of wait time values has a mathematical expectation equal to the mean delay time value.

FIG. 7 is a timing diagram illustrating exemplary communications between an MTC device and a communications network in accordance aspects of embodiments consistent with the invention.

FIG. 8 is, in one respect, a flow diagram of steps/processes that are performed by a communications device in accordance with aspects of alternative embodiments of the invention.

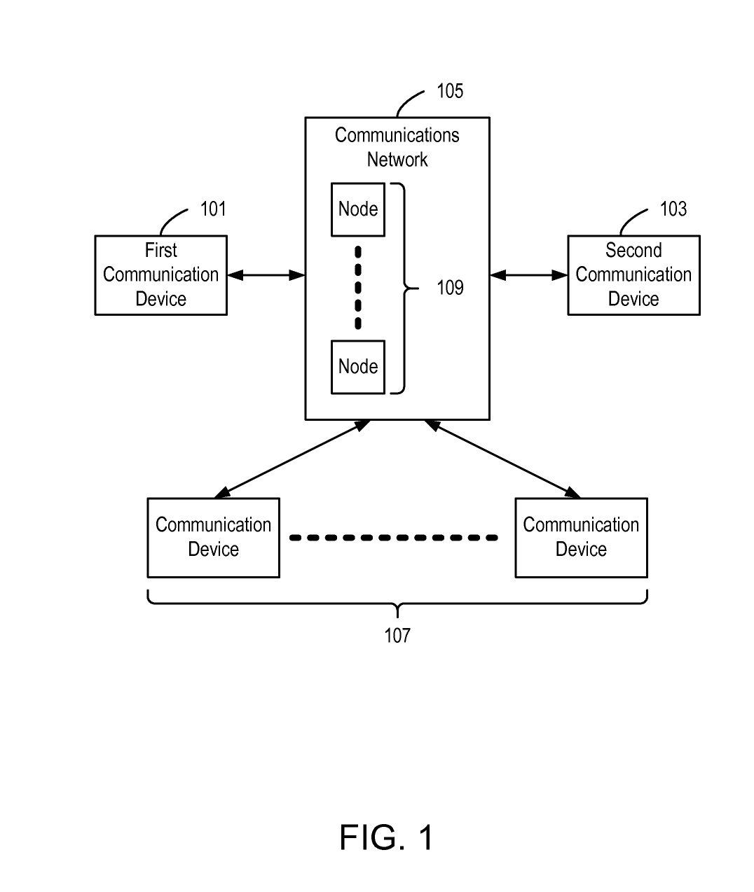

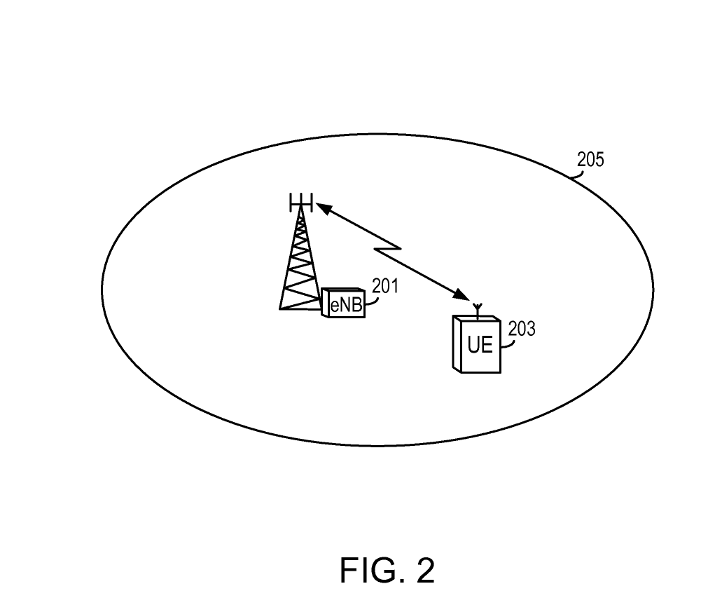

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors). Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

In an aspect of embodiments consistent with the invention, a mechanism is provided whereby, when the communications network load is low enough to permit a plurality of MTC devices to communicate a data packet via the communications network, their network access times are caused to be staggered in a way such that, when considered in aggregation, their mean delay time before accessing the communications network approximates (or approaches) a target mean delay time value set by the network.

To implement this functionality, the MTC device should be provided with the target mean delay time value. This can be accomplished in any number of ways. For example, the information can be stored into a nonvolatile memory device at the time that the MTC device is manufactured or otherwise configured (e.g., at the time that a Subscriber Identity Module—“SIM card”—is installed, wherein the SIM card has the target mean delay time value programmed into it). Alternatively, the target delay time value can be dynamically supplied to the MTC device during its operation. This has the advantage of allowing the network to make adaptations based on present conditions.

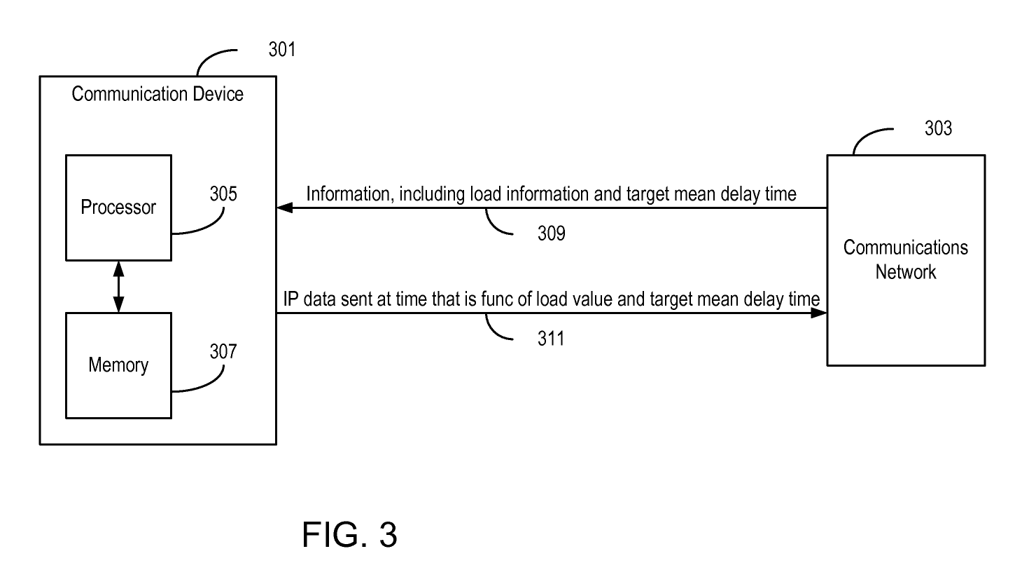

FIG. 3 is a block diagram illustrating one communication device 301 that interacts with a communications network 303. The communication device 301 can be implemented in any of a number of different ways, no one of which is essential to the invention. For example, hardwired circuitry can be used. In the illustrated embodiment, the communication device 301 comprises a programmable processor 305 coupled to a memory device 307 that stores data/information and one or more programs for execution by the processor 305. As illustrated, the communications network 303 communicates (e.g., by means of a broadcast to all MTC devices) information 309 including a network load value (indicating a present load state of the communications network) and a mean delay time value. The communication device stores this in the memory 307. Based on aspects consistent with embodiments of the invention, as will be described further below, the communication device 301 sends data 311 at a time that is a function of the network load value and the mean delay time.

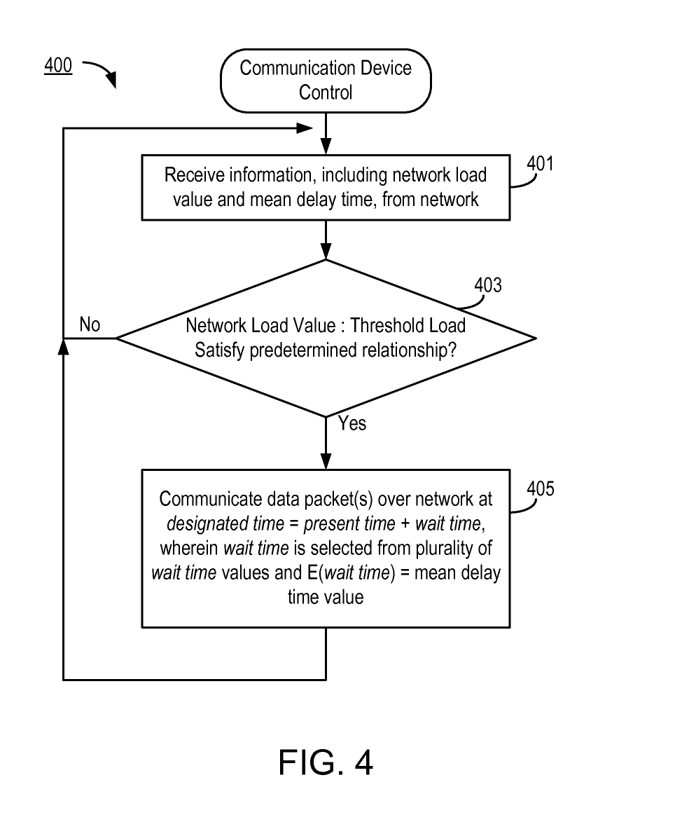

FIG. 4 is, in one respect, a flow diagram of steps/processes that are performed by a communications device in accordance with aspects of the invention. In another respect, FIG. 4 can be considered to depict a controller 400 comprising means for performing the variously described functions.

Operation of the communication device includes receiving, via the communications network, information that comprises a network load value and a mean delay time value (step 401). The network load value is compared with a threshold load value to determine whether a predetermined relationship between the two has been satisfied (decision block 403). For example, in some embodiments it is determined whether the network load value is less than the threshold load value. Such a condition would indicate that the communication device is permitted to communicate a data packet over the communications network.

If the predetermined relationship between the network load value and the threshold load value is not satisfied (“No” path out of decision block 403) then the communication device is not permitted to communicate via the communications network, and processing reverts back to step 401.

If the predetermined relationship between the network load value and the threshold load value is satisfied (“Yes” path out of decision block 403) then the communication device is permitted to communicate via the communications network.

In order to avoid the problem of having many communication devices make this determination at the same time and consequently all try to utilize the communications network at the same time, it is desired to have each communication device determine, for itself, a designated transmission time that will likely vary from one communication device to the next. Accordingly each communication device determines its own “wait time”, which is how long it will wait before beginning to transmit a data packet. It is further desired, however, that the distribution of wait times among the various communication devices be such that the mean of the wait times approaches the mean wait time value received from the network. Therefore, the communication device communicates a data packet over the network at a designated time that is equal to the present time plus a wait time, wherein the wait time is selected from a plurality of wait time values and the mathematical expectation value (“E( )”) of the selected wait time is equal to the mean wait time value received from the communications network (step 405). Following this transmission, processing reverts back to step 401.

It is possible to derive a wait time that will satisfy the requirements of step 405 in many different ways. For example, and without limitation, a plurality of wait time values can be associated with a probability density function that yields the mean wait time value received from the communications network, wherein the probability density function controls the likelihood of selecting any one of the plurality of wait times.

In the general case, the plurality of wait time values can be distributed in almost any way so long as the probability density function yields the mean wait time value. However, the goal is to spread out the different communication devices' access attempts so as not to overload the network at any particular moment in time. Therefore, some distributions and probability density functions are better than others at achieving this purpose. For example, improvement can be achieved by distributing the wait time values in a manner such that the distribution is symmetrical above and below the mean delay time value.

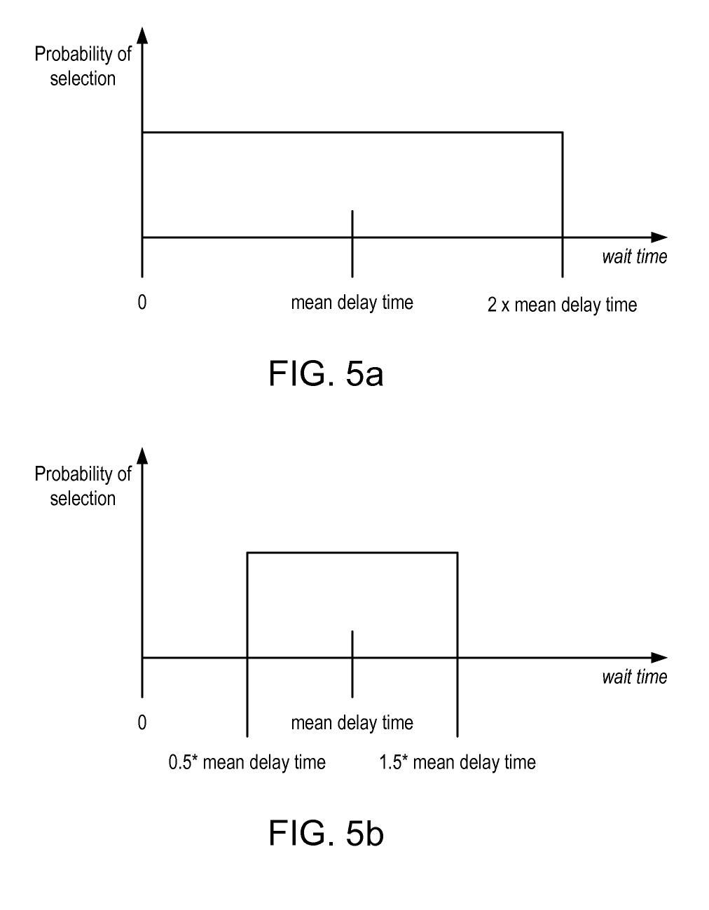

Even further improvement can be achieved by using a uniform distribution of wait time values. One possibility is to use a uniform distribution of wait time values between zero and twice the mean delay value, with an associated uniform probability density function over these values. The probability density function controls the likelihood of any one of the wait time values being selected. This is illustrated in the graph of FIG. 5a. Given the uniform distribution of values between 0 and twice the mean delay value and also the uniform probability density function, all delay values are equally likely to be selected by a communication device. This provides the best chance that the network access attempts made by a plurality of communication devices will be spread out from one another when the network load value permits such devices to access the communications network, and it also achieves the goal of having the mean delay time of these accesses approach the mean delay time value received from the communications network.

To give another of many possible examples, a uniform distribution of wait time values between 0.5*mean delay value and 1.5*mean delay value is achievable if the mean wait time for a given device is determined as

wait_time=MeanTime+(RAND[0 . . . 1]−0.5)*MeanTime,

where RAND[0 . . . 1] is a random number function generating a uniform distribution of numbers between 0 and 1. The illustrated expression for wait_time produces a distribution of wait time values as illustrated in the graph of FIG. 5b.

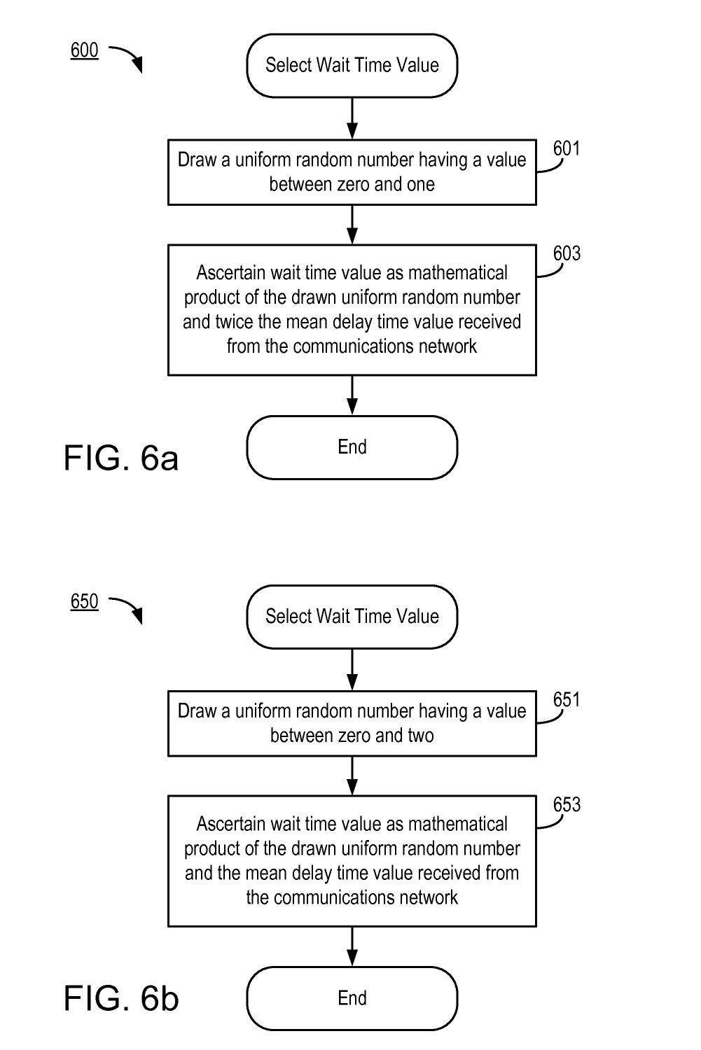

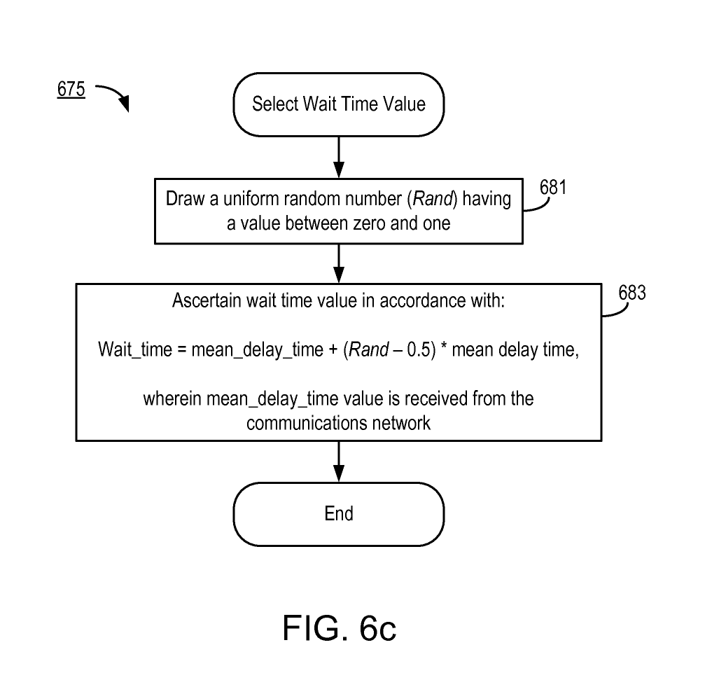

FIG. 6a is, in one respect, a flow diagram of steps/processes that are performed by a communications device in accordance with aspects of the invention for ascertaining one of a plurality of different wait time values, wherein the ascertained one of the plurality of wait time values has a mathematical expectation equal to the mean delay time value. In another respect, FIG. 6a can be considered to depict some elements of a controller 600 comprising means for performing the variously described functions.

In this embodiment, selection of a wait time comprises drawing a uniform random number having a value between zero and one (step 601). Then, one of the plurality of different wait time values is ascertained as the mathematical product of the drawn uniform random number and twice the mean delay time value received from the communications network (step 603).

Those of ordinary skill in the art will appreciate that there are many equivalent ways of achieving the same mathematical result as that depicted in FIG. 6a. For example, and without limitation, FIG. 6b is, in one respect, a flow diagram of steps/processes, that are performed by an alternative embodiment of a communications device in accordance with aspects of the invention for ascertaining one of a plurality of different wait time values, wherein the ascertained one of the plurality of wait time values has a mathematical expectation equal to the mean delay time value. In another respect, FIG. 6b can be considered to depict some elements of an alternative embodiment of a controller 650 comprising means for performing the variously described functions.

In this embodiment, selection of a wait time comprises drawing a uniform random number having a value between zero and two (step 651). Then, one of the plurality of different wait time values is ascertained as the mathematical product of the drawn uniform random number and the mean delay time value received from the communications network (step 653).

To give yet another example, and without limitation, FIG. 6c is, in one respect, a flow diagram of steps/processes, that are performed by yet another alternative embodiment of a communications device in accordance with aspects of the invention for ascertaining one of a plurality of different wait time values, wherein the ascertained one of the plurality of wait time values has a mathematical expectation equal to the mean delay time value. In another respect, FIG. 6c can be considered to depict some elements of an alternative embodiment of a controller 675 comprising means for performing the variously described functions.

In this embodiment, selection of a wait time comprises drawing a uniform random number (Rand) having a value between zero and one (step 681). Then, one of the plurality of different wait time values is ascertained in accordance with

wait_time=mean_delay_time+(Rand−0.5)*mean_delay_time,

wherein mean_delay_time is a value received from the communications network (step 683).

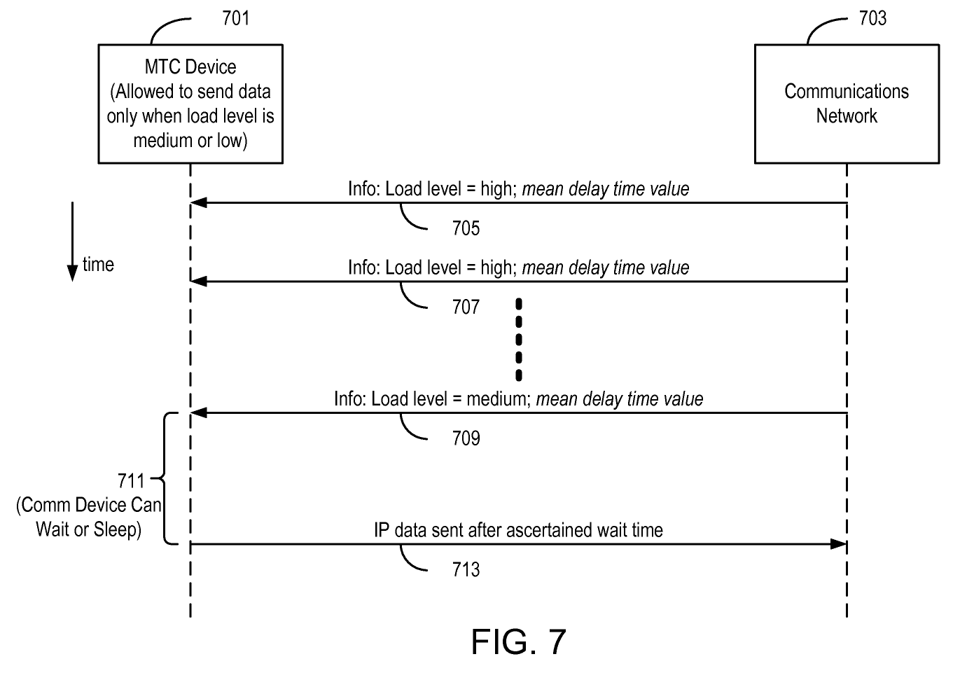

To further illustrate one or more aspects of embodiments consistent with the invention, FIG. 7 is a timing diagram illustrating exemplary communications between an MTC device 701 and a communications network 703 in accordance with the invention. In this example, the MTC device 701 is permitted to send data via the communications network 703 only when the indicated network load level is medium or low. At a first time, the MTC device 701 receives information 705 from the communications network 703 wherein the information 705 indicates (expressly or implicitly) a present network load level equal to “high”; the information 705 further comprises a mean delay time value, but since the load level is too high to permit the MTC device 701 to send data, the mean delay time value is irrelevant.

The same situation holds true at a second time: the MTC device 701 receives information 707 from the communications network 703 wherein the information 707 indicates a present network load level equal to “high”; the information 707 further comprises a mean delay time value, but since the load level is too high to permit the MTC device 701 to send data, the mean delay time value is still irrelevant.

This situation can continue for some period of time. Eventually, the MTC device 701 receives information 709 from the communications network 703 wherein the information 709 indicates a present network load level equal to “medium”; the information 709 further comprises a mean delay time value.

The MTC device 701 is now permitted to send data via the communications network 703, but in accordance with the invention, it determines a wait time as a function of the received mean delay time value. The MTC device 701 waits the determined wait time (step 711) and then sends data 713. In an aspect of some but not necessarily all embodiments, the communication device can go into an idle/sleep mode during the waiting period 711 in order to save power. During the idle/sleep mode, communication circuitry of the communication device operates at a reduced power state since it will not need to be used.

In another aspect of some embodiments consistent with the invention, a wait time is determined (e.g., by means of the steps/processes depicted in FIG. 4) for each data packet to be transmitted.

In alternative embodiments, a wait time is determined (e.g., by means of the steps/processes depicted in FIG. 4) to establish when a first data packet will be communicated, but this is then followed by the communication of one or more additional data packets without having to do any further waiting.

In yet another alternative, the communications network provides the load information in the form of a value having a predefined range, say from 0 to 1. The provided value represents a percentage of all MTC devices that are to be barred from accessing the communications network (e.g., “0” indicates that none are barred, and “1” indicates that all are barred). Each device then draws a random value within the predefined range, and compares its random value to the network-provided value. If the two values satisfy a predefined relationship (e.g., if the drawn value is less than the network-provided value), then the MTC device considers itself barred; otherwise it is permitted to communicate.

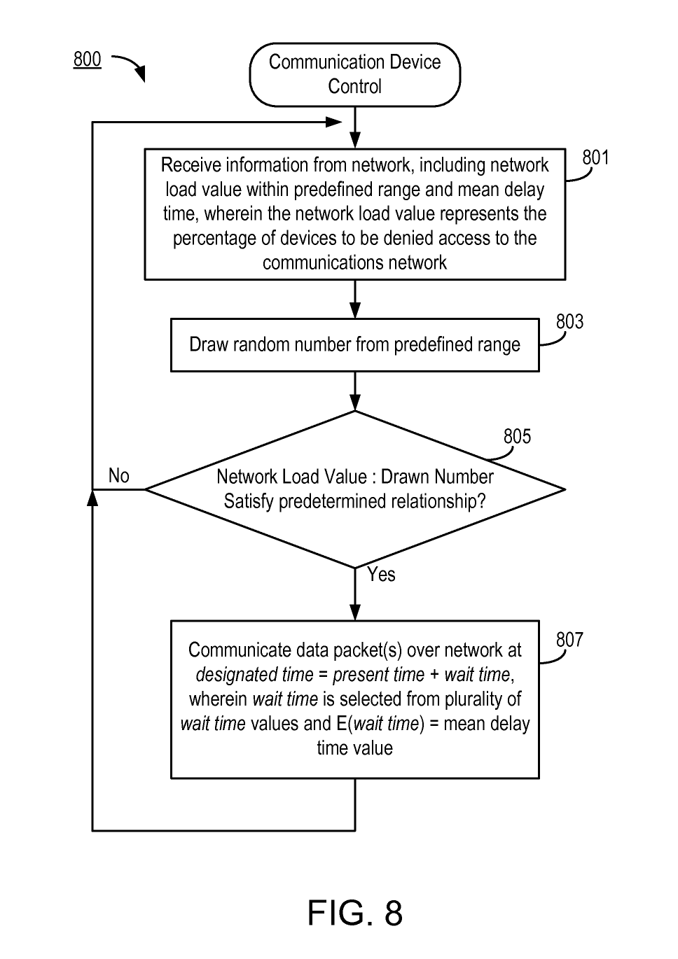

Embodiments consistent with this aspect of the invention are illustrated in FIG. 8 which is, in one respect, a flow diagram of steps/processes that are performed by a communications device in accordance with aspects of the invention. In another respect, FIG. 8 can be considered to depict a controller 800 comprising means for performing the variously described functions.

Operation of the communication device includes receiving, via the communications network, information that comprises a network load value and a mean delay time value (step 801). Here, the network load value is within a predefined range, for example and without limitation between 0 and 1. The network load value represents a percentage of communication devices that should be denied access to the communications network. (In alternative but equivalent embodiments, the network value could represent a percentage of communication devices that should be allowed access to the communications network.) The communication device also draws a random number from within the predefined range (step 803). The network load value is compared with the randomly drawn value to determine whether a predetermined relationship between the two has been satisfied (decision block 805). For example, in some embodiments it is determined whether the randomly drawn value is greater than the network load value. Where the network load value indicates a percentage of communication that should be barred access to the communications network, such a condition would indicate that the communication device is permitted to communicate a data packet over the communications network.

If the predetermined relationship between the network load value and the randomly drawn value is not satisfied (“No” path out of decision block 805) then the communication device is not permitted to communicate via the communications network, and processing reverts back to step 801.

If the predetermined relationship between the network load value and the randomly drawn value is satisfied (“Yes” path out of decision block 805) then the communication device is permitted to communicate via the communications network.

In order to avoid the problem of having many communication devices make this determination at the same time and consequently all try to utilize the communications network at the same time, it is desired to have each communication device determine, for itself, a designated transmission time that will likely vary from one communication device to the next. Accordingly each communication device determines its own “wait time”, which is how long it will wait before beginning to transmit a data packet. It is further desired, however, that the distribution of wait times among the various communication devices be such that the mean of the wait times approaches the mean wait time value received from the network. Therefore, the communication device communicates a data packet over the network at a designated time that is equal to the present time plus a wait time, wherein the wait time is selected from a plurality of wait time values and the mathematical expectation value (“E( )”) of the selected wait time is equal to the mean wait time value received from the communications network (step 807). Following this transmission, processing reverts back to step 801.

The inventive aspects provide a system with a number of advantages. For example, it distributes the load imposed by a plurality of communication devices over the broadcasted target mean delay time instead of having them all attempt to transmit data at the same time.

The use of a deterministic wait time before communication of data also permits the communication device to save power by operating in an idle/sleep mode.

An another advantage over conventional techniques, delivery of application data can be accomplished more quickly because the data transmission time is known in advance, compared to techniques such as Access Class Barring/Service Specific Access Control, in which the application is not aware of the barring time (which is hidden in lower layers of the communication device) and thus the application needs to repeat communication attempts, the outcome of which is uncertain.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of operating a first communications device to communicate with a second communications device by means of a communications network, the method comprising:
operating the first communications device to receive information from the communications network, wherein the information comprises a network load value and a mean delay time value; and
ascertaining whether the network load value satisfies a predetermined relationship with respect to a threshold load value and if said predetermined relationship is satisfied then communicating a data packet over the communications network at a designated time,
wherein the first communications device ascertains the designated time by:
ascertaining one of a plurality of different wait time values, wherein the ascertained one of the plurality of wait time values has a mathematical expectation equal to the mean delay time value; and
waiting an amount of time corresponding to the ascertained wait time, wherein no attempt is made to communicate the data packet over the communications network during the amount of time in which the first communications device is waiting.

2. The method of claim 1, wherein the plurality of different wait time values range from zero to twice the mean delay time value.

3. The method of claim 2, wherein the plurality of different wait time values are symmetrically distributed above and below the mean delay time value.

4. The method of claim 1, wherein ascertaining one of the plurality of different wait time values comprises:
drawing a uniform random number having a value between zero and one; and
ascertaining the one of the plurality of different wait time values as the mathematical product of the drawn uniform random number and twice the mean delay time.

5. The method of claim 1, wherein ascertaining one of the plurality of different wait time values comprises:
drawing a uniform random number having a value between zero and one; and
ascertaining the one of the plurality of different wait time values in a manner that satisfies:
wait time value=MeanTime+(RAND[0 . . . 1]−0.5)*MeanTime,
where RAND[0 . . . 1] is a random number function generating a uniform distribution of numbers between 0 and 1, and MeanTime is the mean delay time value.

6. The method of claim 1, wherein ascertaining one of the plurality of different wait time values comprises:
drawing a uniform random number having a value between zero and two; and
ascertaining the one of the plurality of different wait time values as the mathematical product of the drawn uniform random number and the mean delay time.

7. The method of claim 1, further comprising:
subsequent to communicating the data packet over the network at the designated time, communicating one or more additional data packets without ascertaining additional designated times for communicating the one or more additional data packets.

8. The method of claim 1, further comprising:
the second communication device using the communications network to communicate the information to a plurality of communication devices, wherein the plurality of communication devices comprises the first communication device.

9. The method of claim 1, wherein waiting the amount of time corresponding to the ascertained wait time comprises:
operating the communication device in a power saving mode wherein communication circuitry of the communication device operates at a reduced power state.

10. The method of claim 1, wherein the network load value indicates a class of communication devices that are barred from accessing the network.

11. The method of claim 1, wherein:
the network load value is within a predefined range of values and indicates a percentage of communication devices that should be barred from accessing the communications network; and
the method comprises the first communication device determining the threshold load value by randomly drawing a value from the predefined range of values.

12. An apparatus for operating a first communications device to communicate with a second communications device by means of a communications network, the apparatus comprising:
circuitry configured to operate the first communications device to receive information from the communications network, wherein the information comprises a network load value and a mean delay time value;
circuitry configured to ascertain whether the network load value satisfies a predetermined relationship with respect to a threshold load value and if said predetermined relationship is satisfied then to communicate a data packet over the communications network at a designated time; and
circuitry configured to ascertain the designated time by:
ascertaining one of a plurality of different wait time values, wherein the ascertained one of the plurality of wait time values has a mathematical expectation equal to the mean delay time value; and
waiting an amount of time corresponding to the ascertained wait time, wherein no attempt is made to communicate the data packet over the communications network during the amount of time in which the first communications device is waiting.

13. The apparatus of claim 12, wherein the plurality of different wait time values range from zero to twice the mean delay time value.

14. The apparatus of claim 13, wherein the plurality of different wait time values are symmetrically distributed above and below the mean delay time value.

15. The apparatus of claim 12, wherein the circuitry configured to ascertain one of the plurality of different wait time values comprises:
circuitry configured to draw a uniform random number having a value between zero and one; and
circuitry configured to ascertain the one of the plurality of different wait time values as the mathematical product of the drawn uniform random number and twice the mean delay time.

16. The apparatus of claim 12, wherein the circuitry configured to ascertain one of the plurality of different wait time values comprises:
circuitry configured to draw a uniform random number having a value between zero and one; and
circuitry configured to ascertain the one of the plurality of different wait time values in a manner that satisfies:
wait time value=MeanTime+(RAND[0 . . . 1]−0.5)*MeanTime,
where RAND[0 . . . 1] is a random number function generating a uniform distribution of numbers between 0 and 1, and MeanTime is the mean delay time value.

17. The apparatus of claim 12, wherein the circuitry configured to ascertain one of the plurality of different wait time values comprises:
circuitry configured to draw a uniform random number having a value between zero and two; and
circuitry configured to ascertain the one of the plurality of different wait time values as the mathematical product of the drawn uniform random number and the mean delay time.

18. The apparatus of claim 12, further comprising:
circuitry configured to communicate, at a time subsequent to communicating the data packet over the network at the designated time, one or more additional data packets without ascertaining additional designated times for communicating the one or more additional data packets.

19. The apparatus of claim 12, wherein waiting the amount of time corresponding to the ascertained wait time comprises:
operating the communication device in a power saving mode wherein communication circuitry of the communication device operates at a reduced power state.

20. The apparatus of claim 12, wherein the network load value indicates a class of communication devices that are barred from accessing the network.

21. The apparatus of claim 12, wherein:
the network load value is within a predefined range of values and indicates a percentage of communication devices that should be barred from accessing the communications network; and
the apparatus comprises circuitry configured to determine the threshold load value by randomly drawing a value from the predefined range of values.
